(19) United States
(12) Patent Application Publication
(10) Pub. No.: US 2016/0140653 A1
(43) Pub. Date: May 19, 2016

(54) VIRTUAL CURRENCY BANK

(71) Applicant: Ryan McKenzie, Orlando, FL (US)

(72) Inventor: Ryan McKenzie, Orlando, FL (US)

(21) Appl. No.: 14/541,594

(22) Filed: Nov. 14, 2014

(51) Int. Cl. G06Q 40/02; G06Q 20/36; G06Q 20/38; G06Q 20/06

(52) U.S. Cl. CPC G06Q 40/02; G06Q 20/065; G06Q 20/3678; G06Q 20/3829

(57) ABSTRACT

Described herein are embodiments of a virtual currency bank that includes a sealed container that includes an exterior surface and defines an interior, a QR code, located on the exterior associated with a public key that is tied to a virtual currency account, in that the QR code may be scanned to access the public key in order to add funds to the virtual currency account, and a private key, located in the interior of the sealed container and associated with the public key, in that the private key must be accessed and read to remove or spend funds from the virtual currency account. The sealed container is sealed in a manner so that the private key cannot be accessed without breaking the seal or the container in a manner that cannot be obscured or undone.

### BACKGROUND

Virtual currencies have become ubiquitous. One such virtual currency system, Bitcoin, is a software-based online payment system described by Satoshi Nakamoto in 2008 and introduced as open-source software in 2009. Payments are recorded in a public ledger using its own unit of account, which is also called bitcoin. Payments work peer-to-peer without a central repository or single administrator, which has led the US Treasury to call bitcoin a decentralized virtual currency. Although its status as a currency is disputed, media reports often refer to bitcoin as a crypto-currency or digital currency.

Bitcoin, and other similar virtual currencies, rely on a public “blockchain” to track transactions and allow for public agreement on the order of transactions. When Satoshi Nakamoto first set the Bitcoin blockchain into motion in January 2009, he was simultaneously introducing two radical and untested concepts. The first is the “bitcoin”, a decentralized peer-to-peer online currency that maintains a value without any backing, intrinsic value or central issuer. However, there is also another, equally important, part to Satoshi's grand experiment: the concept of a proof of work-based blockchain to allow for public agreement on the order of transactions. Bitcoin as an application can be described as a first-to-file system: if one entity has 50 bitcoins, and simultaneously sends the same 50 bitcoins to A and to B, only the transaction that gets confirmed first will process. There is no intrinsic way of determining from two transactions which came earlier, and for decades this stymied the development of decentralized digital currency. Satoshi's blockchain was the first credible decentralized solution. Now, attention is rapidly starting to shift toward this second part of Bitcoin's technology, and how the blockchain concept can be used for more than just money.

Commonly cited applications include using on-blockchain digital assets to represent custom currencies and financial instruments (“colored coins”), the ownership of an underlying physical device (“smart property”), non-fungible assets such as domain names (“Namecoin”) as well as more advanced applications such as decentralized exchange, financial derivatives, peer-to-peer gambling and on-blockchain identity and reputation systems. Another important area of inquiry is “smart contracts”—systems which automatically move digital assets according to arbitrary pre-specified rules. For example, one might have a treasury contract of the form “A can withdraw up to X currency units per day, B can withdraw up to Y per day, A and B together can withdraw anything, and A can shut off B's ability to withdraw”. The logical extension of this is decentralized autonomous organizations (DAOs)—long-term smart contracts that contain the assets and encode the bylaws of an entire organization.

Regarding colored coins, tracking the origin of a given bitcoin, it is possible to color a set of coins to distinguish it from the rest. These coins can then have special properties supported by either an issuing agent or a Schelling point, and have value independent of the face value of the underlying bitcoins. Such colored bitcoins can be used for alternative currencies, commodity certificates, smart property, and other financial instruments such as stocks and bonds

Bitcoins are created as a reward for payment processing work in which users offer their computing power to verify and record payments into the public ledger (referred to as “mining”). Individuals or companies engage in this activity in exchange for transaction fees and newly created bitcoins. Besides mining, bitcoins can be obtained in exchange for fiat money, products, and services. Users can send and receive bitcoins electronically for an optional transaction fee using wallet software on a personal computer, mobile device, or a web application.

Bitcoins can be bought and sold with many different currencies from individuals and companies. Bitcoins may be purchased in person or at a bitcoin ATM in exchange for cash currency or fiat money. Participants in online exchanges offer bitcoin buy and sell bids. Since bitcoin transactions are irreversible, sellers of bitcoins must take extra measures to ensure they have received traditional funds from the buyer.

Bitcoin as a form of payment for products and services has seen growth, and merchants have an incentive to accept the digital currency because fees are typically lower than those imposed by credit card processors which generally range from between two and three percent (2-3%). While commercial adoption ramps up, price is currently driven by speculation, contributing to price volatility.

While wallets are often described as being a place to hold or store bitcoins, due to the nature of the system, bitcoins are inseparable from the block chain transaction ledger. Perhaps a better way to define a wallet is something “that stores the digital credentials for your bitcoin holdings” and allows you to access (and spend) them. Bitcoin and its blockchain system use public-key cryptography, in which two cryptographically related keys, one public and one private, are generated. The public key can be thought of as an account number or name and the private key, ownership credentials. At its most basic, a wallet is a collection of these keys. Most bitcoin software also includes the ability to make transactions, enabling the owner of a private holder to sender bitcoins to another account.

Perhaps better termed physical wallets, physical bitcoins are ubiquitous in media coverage and combine a novelty coin with a private key printed on paper, metal, wood, or plastic. Physical bitcoins are not widely seen outside of coverage in news articles, but for those serious about security, storing private keys on paper printouts or in disconnected data storage devices are options.

Bitcoin client software called a bitcoin wallet allows a user to transact bitcoins. A wallet program generates and stores private keys, and communicates with peers on the Bitcoin network. The first wallet program called Bitcoin-Qt was released in 2009 by Satoshi Nakamoto as open source code. Bitcoin-Qt can be used as a desktop wallet for payments or as a server utility for merchants and other payment services. Bitcoin-Qt is sometimes referred to as the reference client because it serves to define the Bitcoin protocol and acts as a standard for other implementations. When making a purchase with a mobile device, QR codes are used ubiquitously to simplify transactions. Several server software implementations of the Bitcoin protocol exist. So-called full nodes on the network validate transactions and blocks they receive, and relay them to connected peers.

The ownership of bitcoins associated with a certain bitcoin address can be demonstrated with knowledge of the private key related to or associated with to the address. If a private key is lost, the user cannot prove ownership by other means. The coins are then lost and cannot be recovered. Because anyone with knowledge of the private key can take ownership of any associated bitcoins, theft can occur when a private key is revealed or stolen.

Integral to bitcoin security is the prevention of unauthorized transactions from an individual's wallet. A bitcoin transaction permanently transfers ownership of bitcoins to a new address. The practical day-to-day security of bitcoin wallets is an ongoing concern. Risk of theft can be reduced by generating keys offline on a secure uncompromised computer and saving them on external storage or paper printouts. U.S. PGPUB 2013/0166455 describes a physical bitcoin token or card that stores an embedded private key, of a cryptographic public-private key set, that is necessary to access a holders bit coins. The physical token or card is physically delivered in a transaction. The embedded private key may be read by scanning a QR-code on the token or card. Since a private key does not change, once it is exposed, it is forever exposed regardless how well it is protected in the future. At the time of exposure the key may not have any funds attached to that key and the breach may not be known by the owner. That owner may they secure the key and attach funds only to find out that the key was compromised when funds are stolen.

What is needed is a physical device that enables saving or storing of bitcoins in a secure manner. What is needed is a physical bitcoin saving device that securely stores an owner's bitcoin private key, or other security data necessary for accessing the owner's bitcoins, until such time as the owner no longer wishes to save such bitcoins. What is needed is a physical devices that securely enables and encourages saving of bitcoins. What is needed is a physical device that, if a bitcoin private key is exposed, will provide an indication or other evidence that the bitcoin was exposed.

### SUMMARY

Described herein are embodiments that overcome the disadvantages described above and provide numerous other advantages. These are provided, for example, by a virtual currency bank that includes a sealed container that includes an exterior surface and defines an interior, a QR code, located on the exterior associated with a public key that is tied to a virtual currency account, in that the QR code may be scanned to access the public key in order to add funds to the virtual currency account, and a private key, located in the interior of the sealed container and associated with the public key, in that the private key must be accessed and read to remove or spend funds from the virtual currency account. The sealed container is sealed in a manner so that the private key cannot be accessed without breaking the seal or the container in a manner that cannot be obscured or undone.

### BRIEF DESCRIPTION OF THE DRAWINGS

Embodiments of a virtual currency (e.g., bitcoin) bank are understood and described in conjunction with the following FIGS., wherein:

FIG. 1 is a diagram illustrating an embodiment of a virtual currency bank in the shape of a piggy bank.

FIG. 2 is a diagram illustrating an embodiment of a virtual currency bank in the shape of a sealed lock box.

FIG. 3 is a diagram illustrating an embodiment of a virtual currency bank in the shape of a credit card container or holder.

### DETAILED DESCRIPTION

Described herein are embodiments of a virtual currency (e.g., bitcoin) bank. Embodiments overcome the problems described above. For example, embodiments provide a physical device that enables saving of virtual currency in a secure manner. Embodiments also provide a physical bitcoin saving device that securely stores an owner's bitcoin private key, or other security data necessary for accessing the owner's bitcoins, until such time as the owner no longer wishes to save or store such bitcoins. Likewise, embodiments provide a physical devices that securely enables and encourages saving of bitcoins. Additionally, embodiments provide a physical device for virtual currencies which is sealed or secured to contain an offline generated private key. Embodiments secure the private key in a manner that will provide a clear indication to the private key owner if the private key has been accessed (e.g., the device will be broken or otherwise unsealed/opened). The associated public key is available through a QR code, displayed characters, or via a printed version.

A single private key can be stored within the container or a multiple signature key which requires two of three keys (or a variation thereof) to transfer the asset. The public and private key pair comprise two uniquely related cryptographic keys (these are basically long random numbers). Below is an example of a public key:

1PKQ4HUiHCiMSWgRbg9WBwyLJKyGGjZojc

The Public Key is what its name suggests—public. It is made available to everyone via a publicly accessible repository or directory. On the other hand, the private key must remain confidential to its respective owner.

Because the key pair is mathematically related, whatever is encrypted with a public key may only be decrypted by its corresponding private key. Having the public key will not allow you to decrypt the private key. Also, very large number of public keys can be generated from a private key. Any assets transferred to a public key can be unlocked using the single private key.

Integral to distributed virtual currencies are the public databases that sequentially record all transactions, known as the block chain. This records current ownership as well as at all points in time. All information is stored on the block chain and the private key is used to change possession of these items.

Embodiments provide a physical representation for virtual currencies in the form of a sealed cash box, sealed piggy bank or other sealed enclosure (various sizes). For example, the container of the virtual currency bank may be as small as, e.g., a matchbox (or smaller) or as large as, e.g., large portable safe (or larger). Embodiments store virtual currency by receiving funds transferred to the exposed public key. The only way to spend any associated funds will be to access the private key which has been secured within the container. The only way to access the private key is to permanently break open the virtual currency bank or the seal that seals the virtual currency bank. Such an activity will necessarily and physically indicate that the private key has been accessed and also eliminate the physical security provided by the embodiment of the virtual currency bank.

With a multiple signature key implementation (2 of 3) only two of three private keys are needed to make a transaction. Two keys can be stored within separate secure containers while the third is held by a third party or stored separately.

Currently, private keys can be printed offline and then stored in a personal safe or safe-deposit box. This process necessarily increases the risk of key exposure to anyone that has access to the printed copy or to the safe or deposit box. The key is also exposed to security risks by the device that generates the key. Each virtual currency bank contains a private key which is needed to transfer the asset and a public key which allows the owner to receive assets. Generating a private key and enclosing it inside a sealed container and then only exposing the public key allows one to receive assets to the secured private key. The current account balance can be monitored on distributed virtual currency networks. The only way to transfer assets will be to access the private key which has been secured within the container. With multiple signature keys, the only way to transfer the assets is to access two of the three generated private keys.

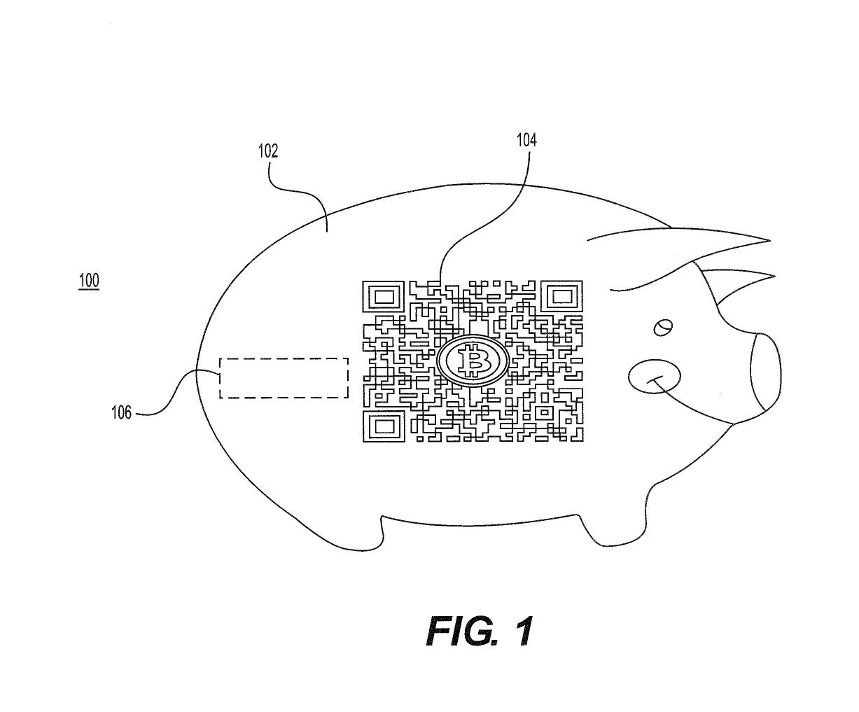

With reference now to FIG. 1, shown is exemplary embodiment of a virtual currency bank 100. The virtual currency bank 100 may be made in the shape of a pig (i.e., as in a piggy bank) as shown, a standard box, or any other shaped container. In embodiments, an important feature is that the virtual currency bank 100 comprises an enclosed, sealed container 102 that cannot be opened without being irretrievably broken or having its seal irretrievably broken (i.e., opening the container 102) in a manner that cannot be obscured, hidden or fixed. A QR code or other electronically-readable code or representation 104 associated with one or more public keys is located on the outside of the sealed container 102. Alternatively, the representation 104 of the public key may be the public key itself A private key 106 (or a representation (e.g., a digital representation) of a private key) is contained within the sealed container 102. The public key(s) associated with the QR code 104 and the private key 106 form a public key-private key pair necessary for accessing virtual currency of the virtual currency bank 100 owner. QR code is a method of retrieving a value without typing it manually. QR codes can represent any text and in the embodiments described herein, the QR code represents the public key (and also in embodiments the private key). The public key(s) are necessary to add funds (deposit) to the virtual currency address or account. The private key 106 is necessary to spend or withdraw the virtual currency. Consequently, the virtual currency tied to the virtual currency bank 100 cannot be spent without breaking open the virtual currency bank 100 container 102.

In embodiments, the private key 106 and one or more public keys are generated together just prior to manufacture of or permanent sealing of the container 102. In a seamless container 102, such as the piggy bank shown in FIG. 1, the private key 106 (or a representation of the private key 106) is placed inside the container 102 while it is being manufactured. The container 102 may include material or device(s) (not shown), e.g., within the walls of the container, that obscures or otherwise prevents scanning or reading of the private key 106 by electronic or other means (e.g., x-ray). Such material may include lead or other metal, various meshes, and other material known to those of ordinary skill in the art.

As noted, multiple public keys may be generated for the one private key 106. Indeed, one can create as many public keys from a private key as wanted, but access to the private key is needed to create the public keys. So when the keys are initially generated, the owner would specify how many public keys wanted. After that the private key is sealed in the container 102 and the owner will not have access to the private key 106 to generate additional public keys.

When initially generated, the private key 106 may only be associated with one or more public keys. In this manner, deposits to the virtual currency bank 100 (i.e., the virtual currency account tied to the private key 106 contained within the virtual currency bank 100) may be made through multiple sources. Embodiments permit the viewing of the account balance without “opening” the virtual currency bank 100 due to all transactions associated with the virtual currency account living on the block chain viewable through online means. Embodiments provide a secure offline method of storing virtual assets.

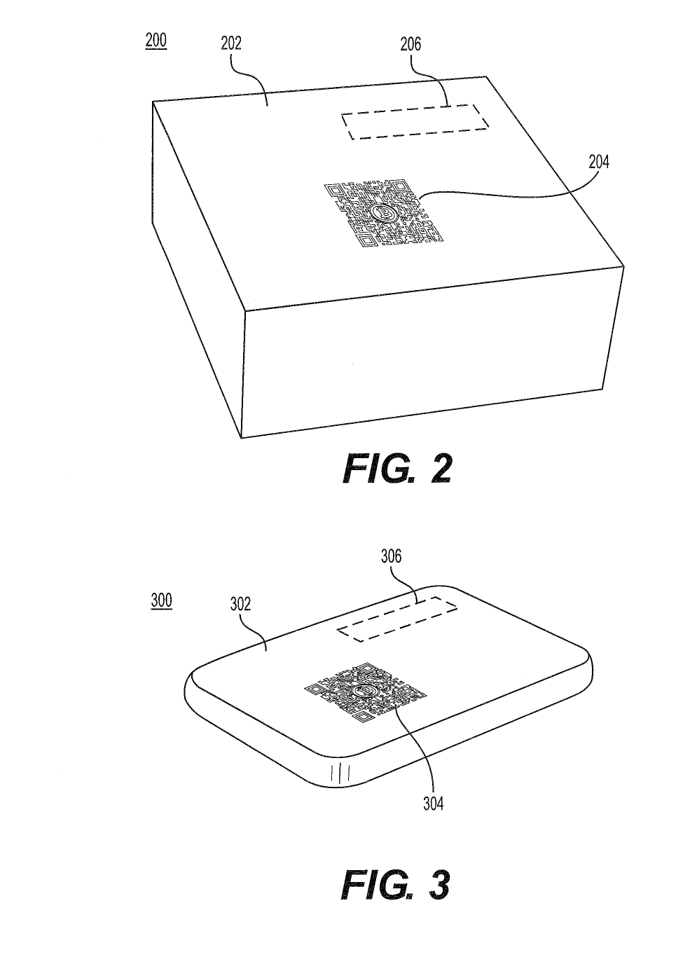

An important feature of embodiments is that the virtual currency bank 100 is a sealed container holding the private key so that the private key cannot be accessed without irretrievably breaking the container or the seal of the container, not the physical design of the container. Consequently, with reference to FIG. 2, another embodiment of the virtual currency bank 200 would be a sealed lock box (cash box) container 202 of various sizes (rather than a piggy bank shape). The sealed lock box container 202 may be a rectangular or square cube shape with a top and bottom (not shown) sealed together with a tamper-proof seal (not shown) known to those of ordinary skill in the art. The QR code 204 may be placed on the outside of the sealed lock box container 202 (e.g., on the top, bottom and/or sides (if any sides)) while the private key 206 (or representation thereof) may be placed on the inside of the sealed lock box container 202 prior to sealing of the sealed lock box container 202. As with the container 102, the sealed lock box container 202 may include material or other devices (not shown) for obscuring or otherwise preventing the scanning or reading of the private key 206 by electronic or other means (e.g., x-ray). Such material may include lead or other metal, various meshes, and other material known to those of ordinary skill in the art. The obscuring material or devices may be located only on the portion of the sealed lock box container 202 that contains the private key 206. The size of the sealed lock box container 202 is only limited by the sizes of the QR code 204 and the sealed private key 206. As these are not large, the sealed lock box container 202 may be relatively small and virtually without thickness.

The tamper proof seal may be formed using any material or technique, known to those of ordinary skill in the art that necessarily prevents reformation after being broke and/or permanently reveals the breaking of the seal. For example, the seal may include chemicals, that when broken or exposed to air or another chemical (e.g., contained within the container) undergoes a permanent, visible change (e.g., a change of color). In this manner, it is known when the sealed lock box container 202 has been opened and the private key 206 accessed.

With reference now to FIG. 3 shown is another embodiment of the virtual currency bank 300. The embodiment shown is in the shape and of the size of a credit card container or holder. Credit card containers or holders are typically small cases that may hold a few credit cards and/or id cards (driver's licenses, green cards, etc.). An advantage of such credit card containers is that they are small, thin and easier to carry than a typical wallet. The virtual currency bank 300 is similarly sized and has similar advantages. As opposed to credit card containers or holders, the virtual currency bank 300 does not open and is instead sealed, consistent with the other embodiments described herein. The private key is contained within the virtual currency bank 300 while the public key or representation thereof 302 is on an exterior surface of the virtual currency bank.

It is an advantage of the virtual currency bank to provide a mechanism for securely maintaining the private key tied to and necessary for spending/withdrawing virtual currency (e.g., bitcoins) from a virtual currency account. It is also an advantage of the virtual currency bank to encourage saving of virtual currency by making the security of the private key contingent on not opening the virtual currency bank container. In this manner, once the virtual currency bank container is opened, the security benefits of a sealed private key are lost. While the private key can continue to be used, without the security of the virtual currency bank, the owner is jeopardizing his account holdings. The virtual currency account owner will need a new virtual currency bank.

In embodiments, multiple private keys can be associated with a virtual currency account. Consequently, to gain the additional security benefit of multiple private keys, a virtual currency account would need to have at least two virtual currency banks (each one containing a private key) associated with the virtual currency account. In some multiple private key systems, there are three private keys and at least two of the three are needed to spend money. Consequently, there may need to be at least three virtual currency banks associated with the virtual currency account. In this manner, for example, parents could give their child one of the virtual currency banks, keep one themselves, and store a third private key in a secure location so that losing one of the three banks does not result in a loss of any secured funds.

In addition to using the public key-private key pair to secure virtual currency, the public key-private key pair secured by embodiments described herein may also be used to secure real or other property, contracts, smart contracts, proof of existence, non-fungible assets, and digital assets. The private key, stored in the virtual bank, may be necessary to retrieve or access such items from a secure file or other repository. For example, for proof of existence: one can hash the data that needs to be time-stamped (to prove its existence as of a certain date) and turn the hashed data into a Bitcoin address. By making a small payment to this address, the payment is stored on the blockchain along with the address to which the payment was made. Since only the hash is stored on the Bitcoin blockchain, no one can tell what data was stored, but given the pre-hashed data one can prove the data was created prior to the block that contains the payment made to that address.

Likewise, for smart property/contracts, a hash of the contract or property deed may be turned into a Bitcoin address that may be secured with the public-key cryptography described herein and secured using the virtual bank. Examples of smart property may include physical property such as cars, phones or houses, non-physical property like shares in a company or access rights to a remote computer. Making property smart allows it to be traded with radically less trust. This reduces fraud, mediation fees and allows trades to take place that otherwise would never have happened. For example, a lender could loan money over the internet taking the smart property as collateral, with the private key held by a intermediary, which should make lending more competitive and, therefore, credit cheaper.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

What is claimed is:

1. A virtual currency bank comprising:
a sealed container that includes an exterior surface and defines an interior;
a representation of a public key, located on the exterior surface, that is tied to a virtual currency account, wherein the public key is utilized to add funds to the virtual currency account; and
a private key, located in the interior of the sealed container and associated with the public key, wherein the private key must be accessed and read to remove or spend funds from the virtual currency account;
wherein the sealed container is sealed in a manner so that the private key cannot be accessed without breaking the seal or the container in a manner that cannot be obscured or undone.

2. The virtual currency bank of claim 1 wherein the sealed container includes material that prevents the private key from being scanned or otherwise read while located in the interior of the sealed container.

3. The virtual currency bank of claim 2 wherein the material includes lead or other metal contained within walls of the sealed container.

4. The virtual currency bank of claim 1 wherein the representation of the public key is a QR code.

5. The virtual currency bank of claim 1 wherein the representation of the public key is the public key.

6. The virtual currency bank of claim 1 wherein the private key is associated with additional public keys.

7. The virtual currency bank of claim 1 wherein the private key only permits removal or spending of funds from the virtual currency account.

8. The virtual currency bank of claim 1 wherein the sealed container is in the shape of a piggy bank.

9. The virtual currency bank of claim 1 wherein the sealed container is in the shape of a standard lock box.

10. The virtual currency bank of claim 1 wherein the sealed container is in the shape and size of flat credit card container.

11. The virtual currency bank of claim 1 wherein the private key is printed on a piece of paper.

12. The virtual currency bank of claim 1 wherein the private key is printed in a manner that prevents reading or scanning of the private key while located in the interior of the sealed container.

13. The virtual currency bank of claim 1 wherein the private key is one of multiple associated private keys wherein more than one of the multiple associated private keys, including the private key of the virtual currency bank must be accessed and read to remove or spend funds from the virtual currency account.

14. The virtual currency bank of claim 13 wherein there are three associated private keys and two of the three private keys, including the private key of the virtual currency bank, must be accessed and read to remove or spend funds from the virtual currency account.

15. The virtual currency bank of claim 1 wherein the private key is printed on an interior surface of the container.

16. The virtual currency bank of claim 1 wherein the private key also is necessary to access assets other than virtual currency.

17. The virtual currency bank of claim 16 wherein the other assets include one or more of the following: real or other property, contracts, smart contracts, proof of existence, non-fungible assets, and digital assets.
